(19) United States
(12) Patent Application Publication
(10) Pub. No.: US 2006/0206748 A1
(43) Pub. Date: Sep. 14, 2006

(54) Backup system for digital surveillance system

(75) Inventor: Kin Keung Dennis Li, Hong Kong (CN)

Correspondence Address: Mr. Eric Chan, 42 Pin Oaks Drive, Phoenixcille, PA, 19460, US

(73) Assignee: MULTIVISION INTELLIGENT SURVEILLANCE (HONG KONG) LIMITED, Hong Kong (HK)

(21) Appl. No.: 11/222,831

(22) Filed: Sep. 12, 2005

(30) Foreign Application Priority Data
Sep. 14, 2004 (HK) 04107000.9

(51) Int. Cl. G06F 11/00

(52) U.S. Cl. 714/4

(57) ABSTRACT

The present invention relates to a backup system for digital surveillance system comprising video cameras, main server(s), networking facilities, a data-switching system, management server(s), backup server(s) and a central control station of an existing surveillance system, wherein a plurality of the video cameras connect to the main server(s); the microprocessor(s) of the main server(s) is installed with software which compresses recorded backup images in real time and the main server connects to the networking facilities; the data-switching system connects to the networking facilities and the management server(s); the management server(s) connects to the backup server(s) and the central control station; the microprocessor(s) of the management server(s) is installed with software which continuously monitors the operation of the main server(s) via the networking facilities, directs the backup server(s) to take over the function of the main server(s) to compress and backup data when malfunctioning occurs, and switches on alarms for malfunctioning indication. The present invention supports a plurality of main systems with one backup system and supports a plurality of video cameras with one main system. It effectively enhances the effectiveness of the backup system.

### BACKGROUND OF THE INVENTION

The present invention relates to a backup system and more particularly pertains to a backup system for digital surveillance system in the field of digital data transmission.

Large-scaled and frequently visited places such as casinos, shopping malls and airports are often installed with surveillance systems. A surveillance system comprises a plurality of video cameras covering all areas of the construction which transmit images to the central control station via networking facilities. Surveillance staff can therefore monitor all areas of the construction to locate and prevent crime timely. Each video camera usually connects to a video recorder or a server installed with software which compresses and saves backup images, with a purpose to keep a backup file of images recorded by the video camera. The backup file may help the police in identifying criminals and can be used as evidence during prosecution.

Since crimes such as theft, robbery and assault may happen at any time, continuous operation of these surveillance systems is required. A surveillance system should also be supported by a comprehensive backup system to avoid any data loss due to malfunctioning. As illustrated in FIG. 1, in order to ensure continuous operation of a surveillance system, the ratio of the main system to the backup system is usually 1:1 for a common surveillance system. Each video camera connects to a main recording system and a backup recording system. The backup recording system continuously monitors the operation of the main recording system. It will take over the function of the main recording system when it detects a malfunctioning of the main recording system so as to give a complete and continuous backup file.

However, the above-mentioned backup system requires huge amount of resources. Apart form the recording system required for the surveillance system itself, another batch of the same number is required for the backup system. At a result, this kind of backup system uses twice the resources. If the main system works well, the backup system serves no other functions. It-is of high redundancy and low economic benefit. This wastes resources but requires high costs of operation, installation, maintenance and management.

### BRIEF SUMMARY OF THE INVENTION

In view of the aforesaid disadvantages now present in the prior art, the present invention provides a backup system for digital surveillance system which can effectively reduce redundancy and costs, increase economic benefit, save resources and avoid any data loss.

To attain this, the present invention provides a backup system for digital surveillance system comprising video cameras, main server(s), networking facilities, a data-switching system, management server(s), backup server(s) and a central control station of an existing surveillance system, wherein a plurality of the video cameras connect to the main server(s); the microprocessor(s) of the main server(s) is installed with software which compresses recorded backup images in real time; the main server(s) connects to the networking facilities; the data-switching system connects to the networking facilities; the data-switching system connects to the management server(s); the management server(s) connects to the backup server(s) and the central control station; the microprocessor(s) of the management server(s) is installed with software which continuously monitors the operation of the main server(s) via the networking facilities, directs the backup server(s) to take over the function of the main server(s) to compress and backup data when malfunctioning occurs, and switches on alarms for malfunctioning indication.

Each of the main servers can connect to up to 16 video camera(s).

Each of the backup servers can support up to 10 main server(s).

The networking facilities connect to a data transmission network available in the marketplace such as Local Area Network (“LAN”), Internet, Integrated Services Digital Network (“ISDN”) and others by real time networking.

The central control station connects to the networking facilities and is provided with a monitor through which surveillance staff can monitor the video images at real time.

When compared with available backup systems, the present invention supports up to 10 main systems with one backup system and supports up to 16 video cameras with one main system. Efficiency of the backup system is therefore effectively enhanced and backup costs are reduced.

### BRIEF DESCRIPTION OF THE DRAWINGS

FIG. 1 shows the network connection of an embodiment of the present invention.

### DETAILED DESCRIPTION OF THE INVENTION

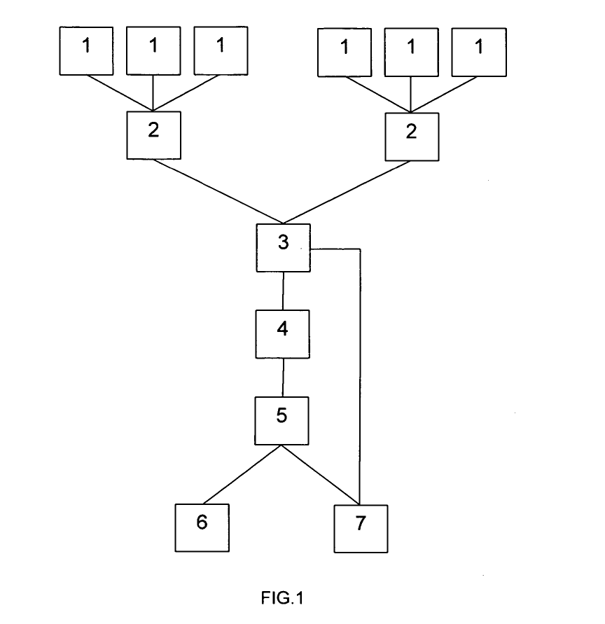

As illustrated in FIG. 1, the present embodiment is a backup system which can be applied to the surveillance system of a casino. It comprise video cameras 1, main server(s) 2, networking facilities 3, a data-switching system 4, management server(s) 5, backup server(s) 6 and a central control station 7 of an existing surveillance system. Hidden video cameras 1 are installed at different locations of the casino. A plurality of the video cameras 1 connect to the main server(s) 2. Each of the main server(s) 2 can connect to 16 video camera(s) 1. The microprocessor(s) of the main server(s) 2 is installed with software which compresses recorded backup images in real time and it connects to the networking facilities 3. The data-switching system 4 connects to the networking facilities 3 and the management server(s) 5. The management server(s) 5 connects to the backup server(s) 6 and the central control station 7. The microprocessor(s) of the management server(s) 5 is installed with software which continuously monitors the operation of the main server(s) 2 via the networking facilities 3, directs the backup server(s) 6 to take over the function of the main server(s) 2 to compress and backup data when malfunctioning occurs, and switches on alarms for malfunctioning indication. Each of the backup server(s) 6 can support 10 main server(s) 2. The central control station 7 connects to the networking facilities 3 and is provided with a monitor through which surveillance staff can monitor the video images at real time.

For example, if there are 160 video cameras 1 in a casino, at least 10 main servers 2 and one backup server 6 have to be installed. When compared with the available surveillance systems which utilize one backup system to support one main system, the present invention can enhance the efficiency of the backup system and save up to 45% of the backup costs.

What is claimed is:

1. A backup system for digital surveillance system comprising video cameras, main server(s), networking facilities, a data-switching system, management server(s), backup server(s) and a central control station of an existing surveillance system, wherein a plurality of the video cameras connect to the main server(s); the microprocessor(s) of the main server(s) is installed with software which compresses recorded backup images in real time; the main server(s) connects to the networking facilities; the data-switching system connects to the networking facilities; the data-switching system connects to the management server(s); the management server(s) connects to the backup server(s) and the central control station; the microprocessor(s) of the management server(s) is installed with software which continuously monitors the operation of the main server via the networking facilities, directs the backup server(s) to take over the function of the main server(s) to compress and backup data when malfunctioning occurs, and switches on alarms for malfunctioning indication.

2. The backup system for digital surveillance system as in claim 1, wherein each of the main server(s) can connect to up to 16 video camera(s).

3. The backup system for digital surveillance system as in claim 1, wherein each of the backup server(s) can support up to 10 main server(s).

4. The backup system for digital surveillance system as in claim 1; wherein the networking facilities connect to a data transmission network available in the marketplace such as Local Area Network (“LAN”), Internet, Integrated Services Digital Network (“ISDN”) and others by real time networking.

5. The backup system for digital surveillance system as in claim 1, wherein the central control station connects to the networking facilities and is provided with a monitor which shows video images.
